(19) United States
(12) Patent Application Publication
(10) Pub. No.: US 2022/0253893 A1
(43) Pub. Date: Aug. 11, 2022

(54) System and Method of Tracking the Efficacy of Targeted Adaptive Digital Advertising

(71) Applicant: Karina Pesah, Passaic, NJ (US)

(72) Inventor: Karina Pesah, Passaic, NJ (US)

(21) Appl. No.: 17/576,993

(22) Filed: Jan. 16, 2022

Related U.S. Application Data
(60) Provisional application No. 63/146,660, filed on Feb. 7, 2021.

(51) Int. Cl. G06Q 30/02; G09F 27/00; G06V 40/20

(52) U.S. Cl. CPC G06Q 30/0242; G09F 2027/001; G06V 40/20; G09F 27/005

(57) ABSTRACT

The invention is a system and method of influencing consumer behavior and encouraging demand for a product or service using physical or electronic displays. The display disclosed in the present application is capable of detecting potential consumers passing by within a certain proximity from said display by utilizing motion sensors, heat sensors, sound sensors, camera and other optical sensors, as well as radar. The presentation on the electronic display is then configured to capture the attention of a detected member(s) of the public (“Subject”). Sensors that work in concert with such display are then directed toward determining whether the Subject has been attracted to the message on the display, and in particular, to the promotional message being shown. If a desired attention level has been achieved, the system then tracks Subject's activity within a finite sphere of activity, timeframe or geographic space to determine whether the message shown to the Subject was effective in influencing Subjects behavior or decisions. After determining successful influences on a previous set of Subjects, the system will then dynamically choose, based on the current Subject detected, which display messages to display to elicit a change in current Subject's behavior to achieve a desired conversion or action.

### CLAIM OF PRIORITY

The application claims the benefit of the provisional application No. 63/146,660 filed on Feb. 7, 2021, the entire contents and disclosure of which are incorporated herein by reference.

### FIELD OF THE INVENTION

The present invention relates to a system of targeted adaptive digital advertising and a method of tracking the effectiveness thereof.

### BACKGROUND OF THE INVENTION

Store signage and display advertising has been a way to advertise brands, promote goods and services, and attract customers for generations. In recent years, increasing number of store signage and window dioramas have been converting to digital screens that replace or enhance physical displays. Digital signage, comprising of one or many digital screens attached to media players, has become a great way to engage with potential customers, extend engagement with existing customers, increase brand awareness, advertise sales, promotions, augment store layouts, and other creative uses. Digital signage has also been used as an on- or off-premises advertising, to broadcast messages, or capture attention of any target audience physically present in or around a target area.

One of many advantages of digital signage is the ability to change messaging or content frequently and quickly as compared to traditional printed or otherwise manufactured signage. Digital advertising systems are relatively more expensive to acquire and maintain then their less sophisticated, but more labor-intensive physical predecessors. The greater expense of the digital display equipment and more sophisticated digital production techniques will, in theory, be offset by reaching and captivating greater number of potential consumers more efficiently.

The downside of physical or digital displays continues to be dearth of adequate measuring means to register and track target audience's engagement, reaction, and conversions. This is especially true where there are multiple messages being displayed on multiple systems across many stores or facilities. For example, a franchise may have digital signage on front doors enticing customers to come in. Subsequently, a different in-store signage may promote other products once clients are inside, but without any way of measuring the effectiveness of either effort, conversion to sales, or whether the efforts may be competing or simply ineffective. The disparate and uncoordinated effort to influence consumer activity makes it difficult to gauge and quantify 1) which specific message or promotion was effective in capturing customer attention and 2) what specific message or message stream prompted a consumer to seek or purchase a product or service or change their behavior in reaction to such message.

Electronic shop window displays or message billboards in front of a store or otherwise, are all forms of digital dynamic advertising. When placed in the immediate proximity with a shop whose wares are being advertised, an electronic billboard or a physical diorama represents the first and possibly the last opportunity to alert a consumer to the goods and services being offered inside the establishment.

A significant downside of digital advertisement is an inability to track its effectiveness. Without proper tracking there cannot be true conversion data to influence future advertising decisions. Meaning that under the current state of the art, the value of an advertisement or a promotional message being displayed on the screen or on an electronically painted display, such as video screen, a flatscreen display, a hologram, billboard, or such is vague and speculative. It also remains a significant challenge to justify costs and determine the rate of return on costly advertising displays, or to justify the expense of an in-house digital advertising production team as it relates to sales. Another downside is, because measuring such efficacy is unavailable, is the inability of such signage to adapt the advertising or message to the specific target audience in real-time. Meaning that a message cannot be tailored to the most fitting target recipient of such message as demonstrated by previous changes in similar recipients in the past.

### SUMMARY OF THE INVENTION

The disclosed system provides the ability to quantify and track the results of passive advertising in a physical medium. Until now consumers walking through a marketplace or passing by a place of business would be assailed by a plethora of various advertising methods that intended to capture consumer's attention to persuade them to patronize a business, product or service. The effects of this advertising could not be measured directly since it was impossible to determine who saw the advertisement and when they saw it. Therefore, any measurement of effectiveness was at best an approximation. The disclosed system provides the ability to quantify the effects of such passive advertisement with greater precision, enabling the advertiser or product vendor to more quickly and accurately gauge consumer engagement to the particular promotional message.

The disclosed invention is a system that measures the immediate and less immediate, or less direct, effects of visual display advertising on target audience. The system includes a projector of advertising, usually a digital screen, a banner, a diorama, a sign, or a billboard. The system then has a plurality of sensors of varying sophistication and utility which a) are geared to detect a specific or general audience, b) are configured to detect engagement of the audience as either presumed consequence of the projector or confirmed behavioral change, c) translate findings back to a databank that is central to the collection of information to measure and track various attributes regarding detected audience, d) measuring the rate of conversion of the projector by comparing the size of audience to the number of converting events, such a sale, being present, or a consummation of certain intended activity, and finally e) adopting the message, if desired, to the subject looking at the message based on similar subjects having done so in the past. The disclosed sensors work within a defined physical space, such as an area in front of a sign or display, a slice of a path, walkway, hallway, promenade or roadway, or a physical target are that, with respect to a particular sensor(s), has been deemed to be the finite target area.

The system is preferably geared to a detection mode that ranges from very basic to increasingly complex. On the very basic end of the spectrum, the data measured would be the message projected as measured against a presumed target audience, all directly compared to the conversion rate. An increasing level of sophistication tracks the degradation or fading effect of the message over time as the captured target audience is presumed to always be bigger than converted audience.

On the more sophisticated spectrum, the system would capture the assumed target audience, detect confirmed engagement, and adapt the message shown to a viewer. The confirmed engagement then becomes a milestone, among many, in the tracking of conversions or a minor conversion event, which can then be compared to ultimate desired level on confirmed conversions.

The plurality of sensors may include radar, motion detectors, and cameras. These sensors are utilized to detect activity within a targeted physical space, for example an area in front the display case, a segment of a sidewalk or a walkway, a portion of a parking lot or a roadway. These or separate sensors are then employed separately, as enhancement or as receivers of detection data to then determine whether the detected audience is in fact the target audience. The sensors can be integrated to track subject of the target audience throughout space or an area. Alternatively, on a more basic level, sensors that are strategically placed can then detect an audience as it gets progressively closer to the intended point of engagement including detection of head position or eye tracking and then an intended point of conversion. Stated more specifically, the sensors aim to capture audience, track the audience through a facility until the audience reaches a display, a shelf or a vending point for the projected product or service, then tracks whether the audience purchased the projected product or service.

The captured data can then be compared to determine the effectiveness of certain projections on certain targeted audiences. The tracking data can be transmitted in real time to a projection coordinator, which may be a human operator or another computer program. The effectiveness of a message can then be intelligently assessed based on real-time, current, historical, or pre-calculated data, and a message can then be either maintained or changed in favor of another message that has shown to be more effective with such a targeted audience, such as a clothing store displaying a dress or a purse product for a lady to a female audience, versus a suit and a shirt for a male audience.

Other detection sensors may include radar, light detection and ranging radar, 3D scanning, retinal or biometric scanners, including computer vision which will preferably be capable of detecting an active response or engagement to a particular message.

It is therefore an object of the present invention to create a system of measuring effectiveness of passive message display, such as billboards, screens or signs.

It is another object to the present invention to create a system of sensors that measures engagement or conversion of the target audience over time.

It is another object of the present invention to utilize the disclosed system to enable an active response to data collected and processed using the system.

It is still another object of the present invention is to select and display a more fitting, dynamic message based on real-time, historical, computed, or pre-computed, or otherwise known factors that favor a better conversion based on the target audience and events.

### BRIEF DESCRIPTION OF THE DRAWINGS

FIG. 1 describes the initial determinations in utilizing the disclosed system.

FIG. 2 is a basic description of the sampling process described in the disclosed system.

FIG. 3 is a diagram of basic associations.

FIG. 4A demonstrates advanced associations that enable the present invention.

FIGS. 4B-4D, demonstrate the method of recording of sensory activity of the disclosed system.

FIGS. 5A and 5B demonstrate the preferred application of the disclosed system in action.

FIGS. 6 and 7 demonstrate some of the data that may be generated for the deduction by additional efficacy machine processes or by a human operator.

FIG. 8 demonstrate the method of tracking a subject through space to see if they achieve the desired action.

FIG. 9 demonstrate the method of switching messages based on historical analysis of a target audience.

FIG. 10 is a diagram demonstrating a response of a particular subject to display of various assets.

FIG. 11 is a diagram demonstrating the disclosed combination that enables the disclosed system and method.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The invention herein uses sensors, artificial intelligence, and machine learning to capture customers engaging with digital signage as it correlates to their physical presence, movement, body language, or any other indication of interaction by the means of sensors such as digital cameras or radar. Additionally, the system would track the customer as they enter and move throughout the store, possibly looking at other signage or simply shopping inside and then having them be present with their purchases as the checkout counter.

The disclosed system identifies a specific message or advertisement. The message is projected via a picture, video or static signage and directed at a target audience. The ultimate objective is to achieve a predetermined goal or conversion. Therefore, at the very least, the system compares the initial target audience against the conversion rate, within a given space of time. The basic concept can then be expanded to track specific target audience, the actions of said audience and potential interference from other projectors within a geographic space. Additionally, dynamic messages can be displayed based on a target audience based on historical successful conversions.

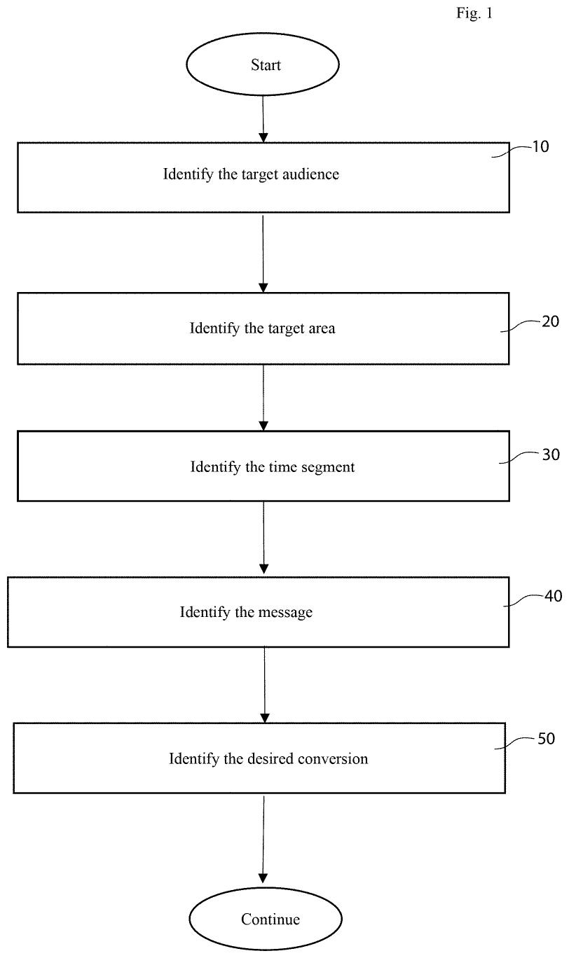

FIG. 1 describes the initial steps of tooling up the dataset of the system, comprising the steps of identification of the target audience 10. The target audience may be people, or a specific subset of people, such as men, women, young men, young women, children, or people being accompanied by other people, or people having a certain dress or mode of behavior. The target is not limited to people, but may include objects, such as vehicles, or particular type of vehicles.

The next step is to identify a finite target area 20. For example, this can be the immediate space in front of a store, an area of a shopping mall or a segment intersecting a section of a highway. As another example, a conventional billboard or a digital billboard on the side of a highway may be equipped with the first sensor, this sensor may be a video camera, a motion sensor, an infrared sensor a radar sensor, an audio sensor or any combination thereof. A mile marker past such billboard may have at least one additional sensor. An exit following the mile marker may have at least one additional sensor, and so forth, until the target location is reached, where the target location contains a plurality of additional sensors. The actions can then be targeted to include a step of exiting vehicle and entering an establishment within a desired proximity of the conversion.

The step of identifying a time segment 30 may include the overall time segment of the efficacy study of the message selected in step 40 or a particular sampling interval within a specific time segment 30, which is geared toward achieving the desired conversion 50. The conversion 50 may also include, but shall not be limited to a consumer transaction, change of behavior, being present at a location, or a service rendered.

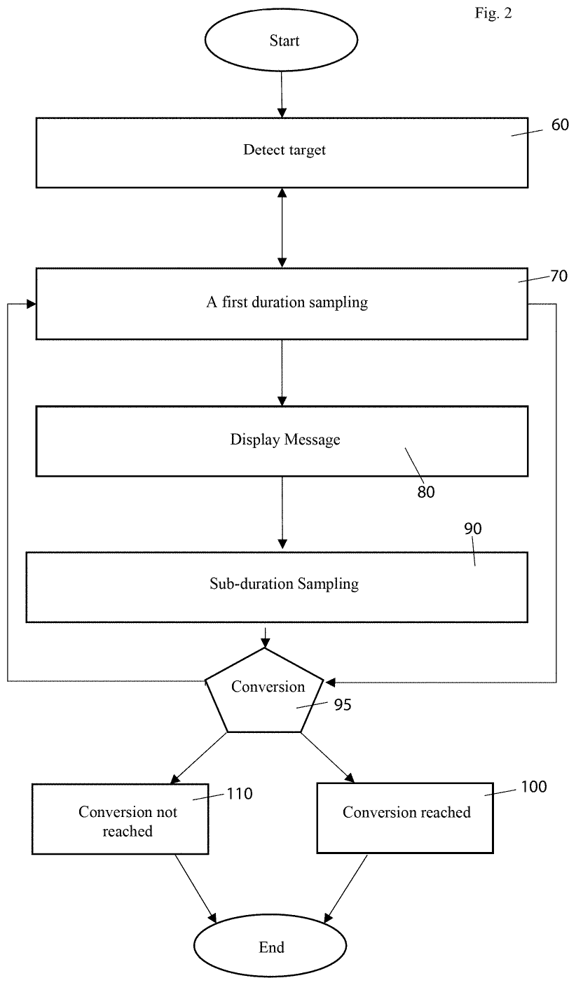

FIG. 2 describes the periodic sampling required to build the database of results. After the identification of the target audience in step 10, the next step is to detect the target and all instances of the desired target within the target area identified in step 20. The initial detection is represented in step 60. Step 70 represents the initial sampling of subjects exposed to the projection of the display message in step 80. The very next step 90 is preferably to determine the immediate effect or change in behavior of target by obtaining the next sampling. The sampling through step 70 continues for the duration period defined in step 30, until the conversion is reached in step 100 or not reached in step 110 at the end of the desired duration, at which point the final sampling is taken to identify the drop off in the number of targeted subjects between the very first sample in step 70 and the very last in steps 110 or 100. Additionally, subsequent samples taken in step 90 may also be analyzed and compared. These metrics can then be used to target a similar audience at some point in the future to display a similar message.

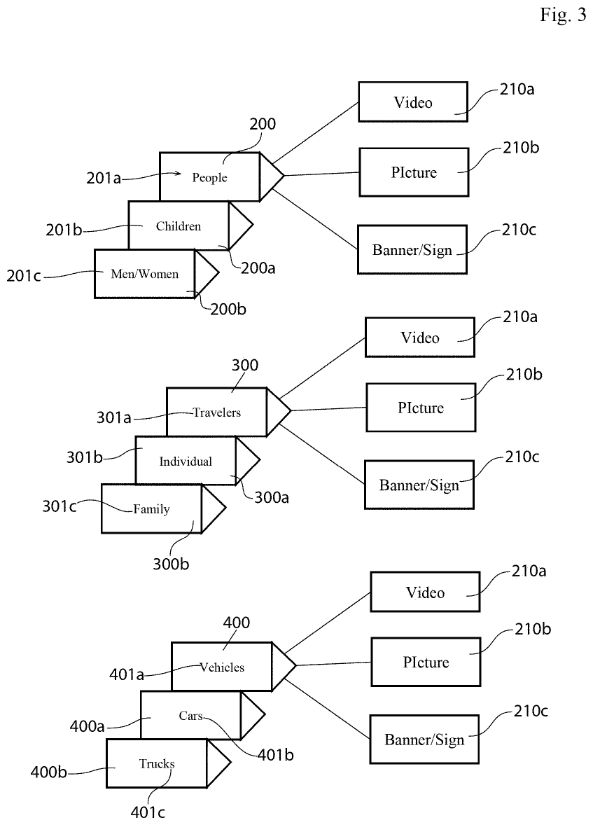

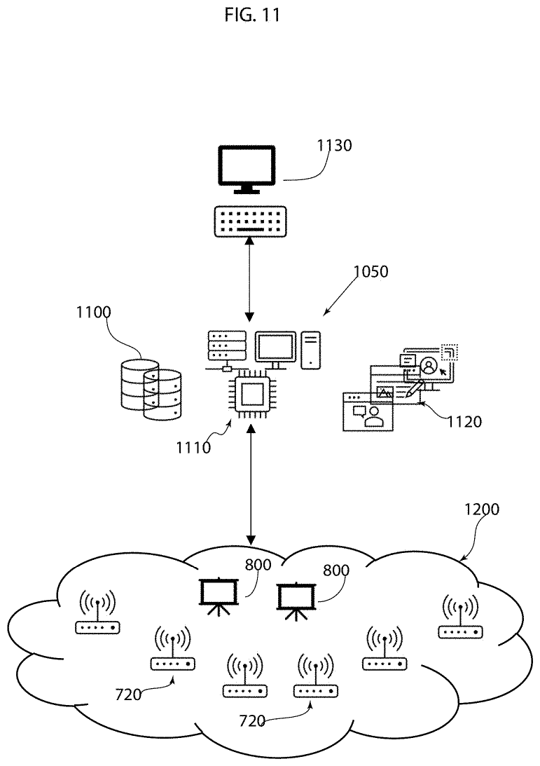

There are several variations on how to organize data necessary to instrument the disclosed system. One particular method of data sorting is described in FIG. 3. The instrumentation preferably occurs at the software application level 1110 (FIG. 11). The software may be written in a prevalent and suitable computer language, such as a .Net, C# or Java style languages, preferably having a messaging and data handling components. The software may be configured to be deployed on Windows®, Unix®, Linux®, or Mac OS® or a mobile derivative thereof.

The target audience is identified as subjects such as people, travelers or vehicles. These subjects are tracked using tags 200, 300 or 400 respectively. The subjects may be varied, such as the overall subject 201a and a more particularly defined subject such as children 201b or men 201c, etc. The subjects may alternatively be sorted into a group of particular interests, with such group then identified by a pattern of behavior. For example, the subject travelers 301a under tag 300 may be anyone carrying a luggage or dressed in a certain manner or displaying certain behavioral patterns, or it may identify whether the traveler 301a is an individual or solo traveler 302b or a family 302c. This specific identification is important in responsive setting, because a family is likely to be interested in family-oriented products and attractions, while an individual would more likely be interested in professional services or particular type of attire.

The given number of intended subjects are then exposed to message assets that carry an informational message. Informational assets may include, but are not limited to, a video message 210a, a picture 210b or a banner/sign 210c, which are displayed to a target audience using at least one projection device, such as a screen, a billboard, a banner or flag. An asset can also simply be a place, such as a shelf with goods or an area of an establishment, such as an entrance or a checkout counter. These are shown to the target audience that may include vehicles 401a, such as automobiles 401b, or trucks 401c. Once the association is made, the system now must record and interpret the pattern of behavior of the subjects that follows the exposure to the message, to determine success or failure of a particular asset, and most importantly to quantify the rate of success of the particular asset.

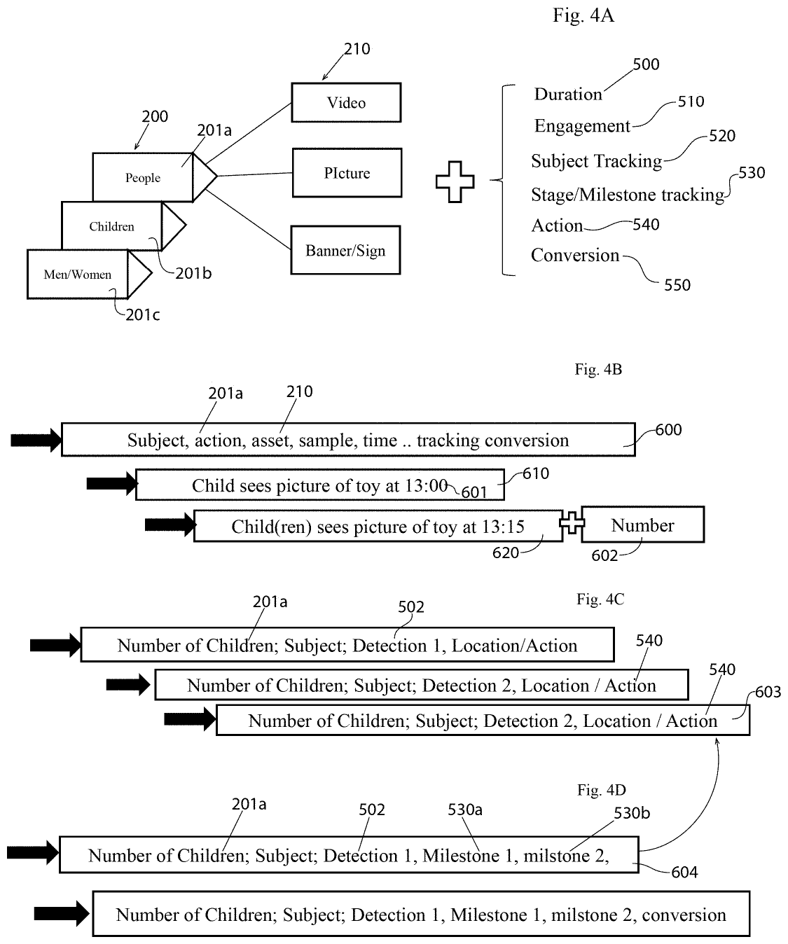

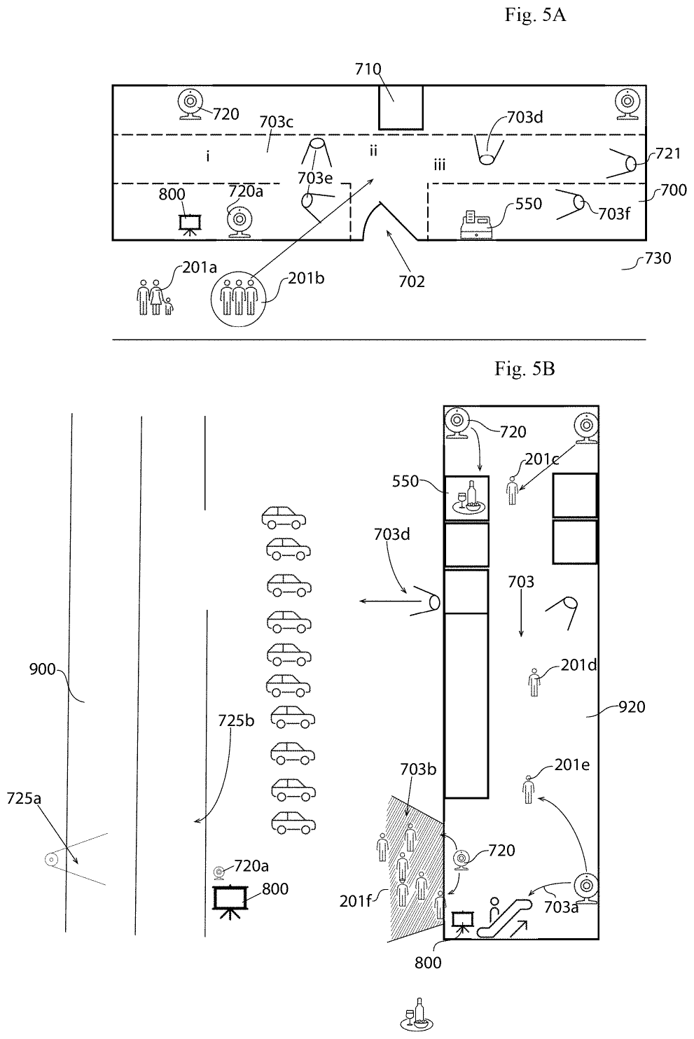

FIG. 4A demonstrates additional attributes that may be associated by the system to embellish, vary, or complete the tracking picture. Shown is the tag 200 having a subject people 201a, together with other possible subjects, such as children 201b, men/women 201c, pet owners, cyclists (not shown), the possibilities of subject variations may be very broad or extremely focused. The subject people 201a are a target audience exposed to the message of the asset 210. The subject 201a and/or can then simply be tracked for a duration of time 500, the level of engagement 510 of the subject 201a (meaning whether the subject was active or passive), particular behavioral tracking 520, milestone tracking 530, some action taken in response to the message 540 or a by reaching the desired conversion 550. It should be noted that conversions 550 may be tracked based on certain pre-conversion milestones as shown in FIG. 4D. For example, the subject 201a who was exposed to a message to purchase a product reached the stand that sold the product but did not end up purchasing it. Other milestones 530a may be more remote. For example, the subject 201a approached the projected asset 210 to take a better look at the message, or entered the establishment, but not proceed further, or entered the establishment, but decided to explore other products. These milestones 530 may be important to demonstrate to a marketing strategist for the user of the system, that a particular informational asset may be particularly well suited to promote a product or service that is only tangentially be related to the asset shown. Another data set may contain a subject 201a who is tracked only by proximity to location or particular action 540. For example, a subjection 201a may be recorded for detection 502, where the set is retained based on how many subjects changed location or took a certain action 540, such as turning to look at the message, and by how many subjects 201a did not take action or change location 540. Either changing location or taking an action, may be measured and tracked separately as an indication of, or a description of engagement 510. The datasets may collect the entire spectrum of factors, such as dataset 603 tracking action location 540 together with milestones 530b. These findings can then be tuned down or muted for a simpler result assessment or amplified for a deeper examination.

Each of these attributes 500-550, contributes to the data synopsis that points to the efficacy or lack thereof of the particular asset 210. For example, the engagement attribute 510 may track to immediate positive, negative or indifferent reaction of the subject 201a, 201b or 201c. The positive, negative or indifferent reaction may be registered with the sensor and processed by the software application through the detection of body language or change of behavior, such as reorientation of body parts in response, or apparent response to a displayed message, a slowing of gait or locomotion, a change of locomotion in the direction toward the asset or an object/location represented in the asset. Such captured subject matter would then be tracked by the software application with the help of tags that would associate a subject 201a various with other milestones 530a The engagement attribute 510 may in turn be combined with another attribute for tracking 520 as a combination pertinent to a subject 201a, or simply tracked by itself. The milestone tracking 530a and b may be a way to track how far a subject gets prior to reaching the conversion 550. This helps quantify the duration efficacy 500 of a particular asset 210. For example, subjects 201a may be tempted to enter the facility, which is the first milestone 530a. Make their way toward the desired conversion 530b, with the path marking another at least one milestone. The subject 201a may then either lose interest or become distracted, for example, due to an improvidently or intentionally competing asset 210. The last milestone, which may be the conversion itself is then quantified.

The sampling is further demonstrated in FIGS. 4B-4D. It should be noted that it is preferable to associate all sensor sample reports to a time stamp 610 of a particular reading. Further, it may be preferable to associate each sensor report with a particular location of the subject or proximity to a desired outcome, or an outcome targeted or monitored by the system. Each data set may be attributed to a particular subject with a number 602 denoting the number of subjects. The subjects may also be grouped and treated together upon detection 502, with the number 602 then denoting the number of groups. FIGS. 4C and 4D demonstrate a similar sampling, but now augmented with additional data.

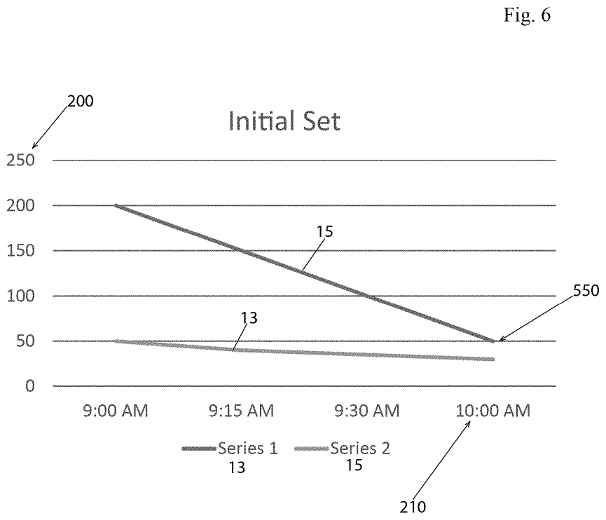

FIGS. 5A and 5B demonstrate the disclosed digital advertising tracking system in action. While the disclosed system may be utilized in a plurality of ways, it is directed at a physical environment delimited by boundaries, such as a facility 700. The facility 700 may be one shop, or a mall facility 920. The system utilizes visual presentation displayed on projection devices with the objective of motivating subjects within the physical area, or in a proximity to the physical area, to arrive at a certain desired location or conversionary outcome, such a purchase or procurement of service. The system comprises a plurality of sensors 720 and 721 all working in concert. The initiation occurs at the projection 800, which displays the asset promotional message, such as a picture, video or banner. Different sensors are then directed at particular strategically important junctions to detect the presence of the target audience and the effect of the asset on this target audience. The sensor 720a may be a camera, or a combination sensor, such as a camera, motion detection, radar, lidar, retinal scanner, and additionally may be able to detect facial features.

In FIG. 5A the conversion is the point of sale 550. The initial detection is directed towards a segment of a sidewalk 730. The system may be monitoring for more than one target audiences. As shown in FIG. 5A, the target audience are families 201a and men 201b. The second junction is the front door 702 where at least one sensor 703e detects action or level of engagement. For example, if the area where the product is being shelved is 710, the sensor 703e may be detecting if member(s) of the target audience is actively seeking out the location 710. The physical location where the advertised product is shelved is likely to also become one of the focus areas if a sensor(s) is trained on the area and its immediate vicinity. Besides for tracking actual conversions, the tracking of the actual shelving may be used to determine which area of the physical location is a better conversion spot for the item being promoted. Or even as a guide on what types of displays lead to more conversions. The next set of sensors may be placed at junctions i, ii, or iii which would measure whether the target audience is getting closer or further away from the targeted location 710. Sensors 703f, d, e and f similarly aim to detect the prevalence of presence of target audience within vicinity of the milestone location 710 in comparison to other areas of the facility 700.

FIG. 5B, the conversion 550 is a subject entering a restaurant. In both cases the target audiences are 201a-201f which are first detected at the target area, in this case a section 725a and 725b of the roadway 900 and shown a message promoting such restaurant. The subjects 201a-f are captured by the sensor 703b. Additional sensors 720 within the facility 920 track the subjects throughout the location to determine whether the conversion 550 such as individual walking through the door of the restaurant would occur.

Each of the sensors 720, 720a, 703, or 703a-f may be a device configured to perform subject identification and tracking through artificial intelligence using a hookup to the software application 1110 (FIG. 11) where sensors may send data or video for analysis of subjects and outcomes. Each of the sensors 720, 720a, 703, or 703a-f may a) detect the presence of a potential subject, b) determine if the subject has been seen before in physical space or time, c) is a member of the targeted group, d) has been interested by asset message or is disinterested, e) is moving towards conversion or away from it, and f) the degree to which the subject achieved the desired outcome. This processing can also be done remotely on a server that analyses data or video from sensors to compute results in steps a-f and other metrics. The sensors in combination made intelligent through the use of a computing device 1110 may obtain information from a database or a pre-computed algorithm to then direct the sensors to either capture or ignore the detected activity and track the outcomes.

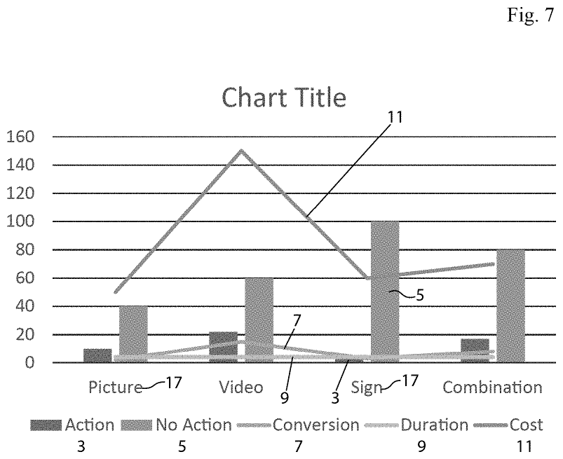

FIG. 6 demonstrates an initial set showing the activity of two groups of target audiences. One group is represented by line 13 and the other group by line 15, both groups converge toward a conversion goal 550 over duration of time. Lines 13 and 15 demonstrate effectiveness of a particular asset in engaging more targeted subject toward a desired goal, in this case the convergence 550. In this case the line 15 demonstrates that the asset it represents, namely, a promotional message shown to a targeted group of subjects, is capable of getting more of the subjects to respond, but then loses effectiveness rather quickly, whereas the asset represented by line 13, while does not engage as many subject specimens, is capable of keeping more of them motivated.

FIG. 7 includes additional factors that may dictate effectiveness of a projected message. For example, action 3 or inaction 5 in response to a particular message 17. Measured over a space of time 9, while tracking milestones and conversions 7. The conversion 7 is now compared against cost 11 to determine whether the additional conversions in certain circumstances can be obtained by changing the message, pricing, asset, store layout, customer traffic, or other factors.

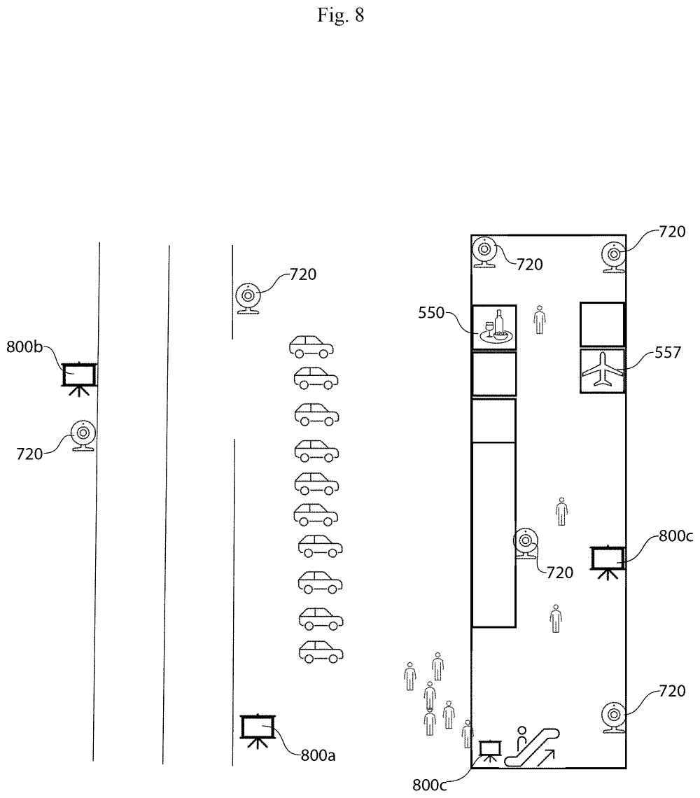

FIG. 8 is another contextual demonstration of the disclosed invention. Shown now are several different projection devices 800a, 800b and 800c. These show different messages of the same product or of different products. The messages advertise two different conversion points. A system of sensors 720 is configured to be able to determine to which projection the target audience is responding to and effectiveness of each conversion. The sensors may have more than one loyalty. Meaning the same sensor or a set of sensors may be reporting a proclivity of a group toward conversion 550 and conversion 557 as compared against each other, or in isolation, for their distraction factors. Targets can also be uniquely identified by some features that, when taken together are used to identify a specific target and then store such identities in a databank to be identified and tracked over time, such as when the subject is recognized by the same or similar sensor at a different time, over a period of hours or days, or place at the same or a different location such as a different location of the same franchise. For example, a subject was attracted by a message or an asset, but did not enter the establishment; however, the subject did return the next day for a successful conversion.

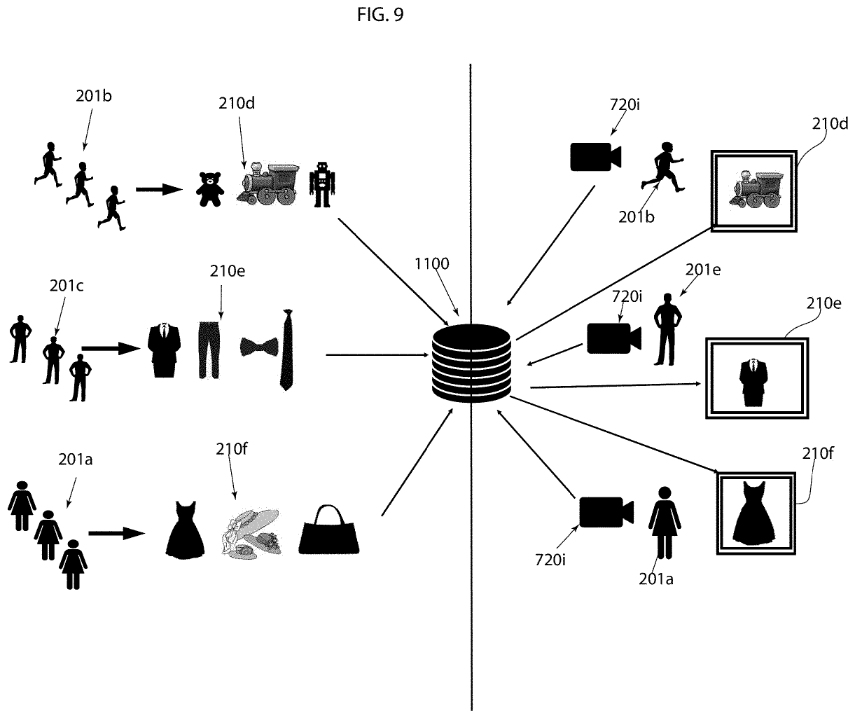

FIG. 9 is another contextual demonstration of the invention. Shown are three different target groups 201a, 201b, and 201c that have in the past purchased items 210d, 210e, or 210f from an establishment utilizing the disclosed system for its adaptive advertising. These successful conversions are recorded in the databank and pre-calculated for future success. In the future, when a similarly classified subject 201b approaches a target area, the message on the digital display 210d would change in real-time for that subject based on the historical, pre-calculated successful conversion metric for a similarly identified subject in the past and display a similarly classified item 210d for that person to entice the conversion, such as purchasing the same or similarly classified item.

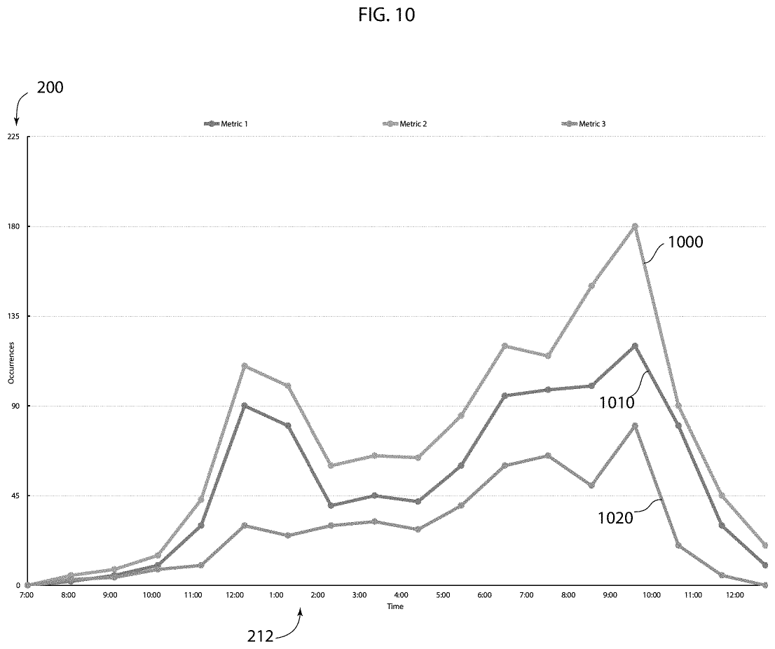

FIG. 9 demonstrates the utility of the adaptive response of the disclosed system. Through ongoing detection recorded in the databank 1100 the software application 1110 (FIG. 10) recognizes that subjects including children 201b have shown interest in messages advertising toys 210d but have not shown as much interest in messages demonstrating clothes 210e or 210f. Similarly, the subject of men 201c may have shown more interest in male apparel then in assets comprised of toys 210d or female clothes 210f. The same is true for female subject 201a, who are more enticed by demonstration of female apparel 210f then other messages. The sensors 720i can then serve as a means of regulating the promotional activity being streamed over projection devices 800. For example, if a large proportion of youngsters is detected in the target area of a sensor 720i, the projection device 800 would be directed to display messages geared toward this audience, namely, toys 210d.

FIG. 10 demonstrates that the disclosed system is a good measure of an overview of interests of a particular subject. For example, the Y axis 200 represents conversions of female subjects, while the X axis 212 represents a passage of time during which various assets were displayed to female subjects. The resulting line 1000 represents female apparel, line 1010 represents messages featuring toys, and line 1020, the least effective, representing when male apparel assets were shown to female subjects. Such measures of conversions relative to subject and assets shown may assist the software application 1110 or a human regulator in determining what messages should be shown to a mixed crowd of subjects. For example, a mixed crowd of subjects consisting of children 201b and women 201a may be shown both the female apparel messages and toys. This group should not be shown assets describing car parts or shaving products (not shown). On the other hand, if men are significant proportion of mixed subjects, shaving products may be a better choice over toys or apparel.

FIG. 11 demonstrates the combination of equipment required to enable the disclosed system. The disclosed system may operate over a network, such as the Internet, wireless, or a local area network LAN. A plurality of sensors 720 including, but not limited to camera, radar, lidar, motion detectors and projection devices 800 are tied through a network to a computer hardware comprising a central processing unit 1110, database 1100 that operate software application modules 1120 locally or across a network. The combination may be controllable through an operating terminal 1130.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. An adaptive system of message projectors comprising; a physical environment, said physical environment defined by physical boundaries; said physical environment having a point of access into said physical environment; at least one message projector coupled with at least one sensor associated with said physical environment; said at least one sensor configured to be directed by a software application; said at least one sensor configured to detect a subject within a targeted physical area in response to an asset displayed by message projector; a plurality of additional sensors detecting a set of activity factors of said subject within said physical environment; and a data bank; said data bank configured to store instances of detection of said subject by said at least one sensor and said plurality of additional sensors in association with at least one asset for use by said software application in targeting additional of said subject.

2. The adaptive system of claim 1; further comprising additional message projectors strategically positioned in association with said at least one message projector.

3. The adaptive system of claim 2; wherein said at least one projector and said additional message projectors configured to be directed by said software application.

4. The adaptive system of claim 3; wherein said at least one sensor and said plurality of additional sensors configured to detect targeted subject attributes in connection with a specific asset displayed on said at least one projector, or at least one of said additional message projectors.

5. The adaptive system of claim 4; wherein said software application determines effectiveness of said asset in connection with said subject.

6. The adaptive system of claim 5; wherein said at least one projector or said additional message projectors displaying an asset when said at least one sensor detects said subject wherein said asset being displayed in accordance to effectiveness of said asset in connection with said subject.

7. The adaptive system of claim 6; wherein said at least one message projector or said additional message projectors comprise a group of a message sign, a billboard, a digital display, or a physical focus area or any combination thereof.

8. The adaptive system of claim 6; wherein said at least one sensor or plurality of additional sensors is a group comprising a video sensor, audio sensor, motion sensor, infrared sensor, temperature sensor or radar, or a light emitting radar, or any combination thereof.

9. A method of creating an adaptive promotional system in a physical setting delimited by identifiable physical boundaries comprising; a step of displaying an asset on a message projector; a step of determining a targeted conversion; a step of identifying a subject to be targeted by said asset.

10. The method of claim 9, further comprising a step of detecting a desired subject in a targeted physical location in proximity to said message projector.

11. The method of claim 10, wherein said asset message projector is a physical area containing at least one of said assets; wherein said asset being a physical item of interest to said subject.

12. The method of claim 10, further comprising the steps of recording sensory readings within said physical settings that are configured to be sequential, including additional factors to be considered in combination with said detections.

13. The method of claim 11, further comprising a step of detection of a subject being reported to a software application; and a step of said software application directing an asset to be shown to said subject being detected.

14. The method of claim 11, further comprising the steps of recording sensory readings within said physical settings that are configured to be sequential, including additional factors to be considered in combination with said detections; and a step of detection of a subject being reported to a software application; and a step of said software application directing an asset to be shown to said subject being detected.

15. In combination an adaptive system of directing interest towards a desired outcome comprising; at least one sensor; said at least one sensor connecting to a computer system configured to operate a software system; said software system operating in parallel with a databank; wherein said software system receiving readings from said at least one sensor; and wherein said at least one sensor configured to operate in association with at least one asset.

16. The combination of claim 15, wherein said asset is a physical space or a projection device

17. The combination of claim 16, wherein said sensor targets a physical area associated with said at least one asset.

18. The combination of claim 16, wherein said software application is configured to determine effectiveness of sensory readings from said at least one sensor based on historical performance.

19. The combination of claim 16, wherein said software application further comprises a operating terminal; wherein said utility portal is configured to dynamically display messages to targeted subjects.

20. The combination of claim 19, wherein said software application is configured to autonomously control assets appearing on said at least one projection device in response to determination of effectiveness of said asset.
